(19) United States
(12) Patent Application Publication
(10) Pub. No.: US 2009/0233817 A1
(43) Pub. Date: Sep. 17, 2009

(54) Methods for Testing the Effect of Polymer Additives on Wax Deposition from Crude Oils and Reducing Wax Deposition from Crude Oil During Pipeline Transmission

(76) Inventors: Robert M. Kriegel, Decatur, GA (US); Jack F. Tinsley, Mannhelm (DE); Rajesh K. Saini, Duncan, OK (US); Robert K. Prud'homme, Lawrenceville, NJ (US); Ian D. Robb, Duncan, OK (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/048,735

(22) Filed: Mar. 14, 2008

(51) Int. Cl. C09K 8/524

(52) U.S. Cl. 507/90; 73/61.76; 73/61.78

(57) ABSTRACT

Compositions and methods for reducing wax deposition from a crude petroleum during transmission of the crude petroleum through a pipeline are provided. Compositions and methods of testing the deposition of wax from a petroleum sample are also provided.

### TECHNICAL FIELD

The present invention generally relates to the field of reducing wax deposition in the pipeline transmission of crude oil.

### BACKGROUND

Several publications and patent documents are cited throughout the specification in order to describe the state of the art to which this invention pertains. Full citations of these references can be found throughout the specification. Each of these citations is incorporated herein by reference as though set forth in full.

Wax deposition has been a long-standing problem in oil recovery, particularly in deep-sea pipelines, where low temperatures readily crystallize long-chain paraffins in the oil. Among the methods to combat wax deposition, polymer additives have often been used with success (Becker, J. R. (2001) J. Pet. Technol., 53, 56-57; Bilderback et al. (1969) J. Pet. Technol., 21:1151-1156). However, tests to evaluate the effectiveness of wax deposition control agents, such as cloud point and pour point tests, generally observe bulk properties and not actual deposition. Furthermore, such tests do not simultaneously consider effects of flow, cooling rate, and composition, which have been shown to be critical to the structure and properties of waxy gels (Singh et al. (1999) J. Rheol., 43:1437-1459; Venkatesan et al. (2005) Chem. Eng. Sci., 60:3587-3598). Cloud point or pour point tests generally use one cooling rate and impose no controlled flow field (American Society for Testing and Materials (ASTM) International. D2500-05, a standard test method for cloud point of petroleum products; ASTM International. D97-05, a standard test method for pour point of petroleum products). Another recently developed test induced deposition onto a small disk in a stirred vessel, using small sample quantities and very short test times (Wang et al. (2003) Pet. Sci. Technol., 21:369-379). However, the flow fields are difficult to directly relate to pipeline conditions.

Controlled laboratory deposition studies examining wax deposition date back several decades (Jessen et al. (1958) Trans. Soc. Pet. Eng., 231:80-84). Recent studies have contributed significantly to the current understanding of wax deposition, allowing accurate mathematical modeling of the laboratory experiments (Brown et al., Measurement and prediction of the kinetics of paraffin deposition. In The 68th Annual Technical Conference and Exhibition, Houston, Tex., Oct. 3-6, 1993; Society of Petroleum Engineers: Houston, Tex., 1993; pp 353-368; Parthasarathi et al. (2005) Energy Fuels, 19:1387-1398; Singh et al. (2000) AIChE J., 46:1059-1074). A survey of deposition studies shows that four key factors determine the rate and nature of the deposit formed: the flow rate, the temperature field, the composition of the oil, and the nature of the surface (Singh et al. (2000) AIChE J., 46:1059-1074; Creek et al. (1999) Fluid Phase Equilib., 160:801-811; Weingarten et al. (1988) SPE Prod. Facil., 121-126; Burger et al. (1981) J. Pet. Technol., 1075-1086; Cole et al. (1960) Oil Gas J., 58:87-91; Singh et al. (2001) AIChE J., 47:2111-2124; Jorda et al. (1966) J. Pet. Technol., 18:1605; Kok et al. (2000) Pet. Sci. Technol., 18:1121-1145; Parks et al. (1960) Oil Gas J., 58:97-99; Zhang et al. (2002) J. Pet. Sci. Eng., 36:87-95). As used here, temperature field includes consideration of the temperature of the bulk oil, the temperature of the deposition surface, the relation of these temperatures to the cloud point, and the temperature gradient. The composition of the oil comprises the type and molecular weight of the paraffins, the amount of these paraffins, and the presence of additives as well as other components in the oil that could affect deposition. Most studies use a closed system that continuously passes a warm waxy solution over a cold surface to induce deposition, measuring the deposit thickness with time. However, it has been shown that deposits must not only be characterized by height but also by composition. This is due to the fact that the wax deposit is a gel with a large fraction of trapped oil whose structure and composition is dependent upon the thermal and shear conditions (Singh et al. (1999) J. Rheol., 43:1437-1459; Venkatesan et al. (2005) Chem. Eng. Sci., 60:3587-3598).

While deposition studies considering the effects of polymers have been performed, they are relatively few in number (Brown et al. (1993) supra; Hennessy et al. (1999) J. Cryst. Growth, 199:830-837; VanEngelen et al., Study on flow imporvers for transportation of bombay high crude oil through submarine pipeline. In The 11th Annual Offshore Technology Conference; Houston, Tex., April-May, 1979; p 1385.). Such studies have confirmed the important role of temperature and shear conditions. However, they usually track changes in deposit mass or height without examining the changes in deposit composition or morphology. The potential benefit from deposition studies with polymers is shown in the studies by Brown et al., where half of the recommended additives were ineffective or actually increased paraffin deposition (Brown et al. (1993) supra).

### SUMMARY OF THE INVENTION

According to one aspect of the invention, a method of reducing wax deposition from a crude petroleum during transmission of the crude petroleum through a pipeline is provided. The method includes the steps of: (a) mixing with the crude petroleum a polymer selected from the group consisting of: (i) a poly(maleic anhydride-co-a-olefin) modified with long chain alkyl amine; and (ii) a poly(maleic anhydride-co-alkyl vinyl ether) modified with long alkyl amine; (iii) poly(maleic anhydride-co-styrene) modified with long chain alkyl amine; and (b) transmitting the crude petroleum through a pipeline.

According to another aspect of the invention, a method of testing the deposition of wax from a petroleum sample is provided. The method includes the steps of: (a) assembling a test cell comprising: (i) a first surface, wherein the first surface is defined by a heat-conductive body; (ii) a second surface, wherein the second surface is defined by a transparent plastic plate; and (iii) a channel for flow between the first surface and the second surface, wherein the channel is partially defined by a spacer positioned between the first surface and the second surface; (b) controlling the temperature of the first surface; and (c) passing the petroleum sample through the channel at a controlled temperature.

According to yet another aspect of the instant invention, a deposition cell for monitoring the deposition of wax from a petroleum sample under controlled shear stresses and thermal gradients is provided.

### BRIEF DESCRIPTION OF THE DRAWINGS

A more complete understanding of the present disclosure and advantages thereof may be acquired by referring to the following description taken in conjunction with the accompanying drawings, in which:

FIG. 1 shows the composition of multicomponent wax as determined by GC.

FIGS. 2(a) and 2(b) show a parallel-plate deposition cell, where FIG. 2(a) shows an assembled deposition cell, with the direction of flow indicated by arrows, and FIG. 2(b) shows the upper plate, spacer, and the lower plate (from top to bottom) that form the deposition channel. T₁-T₄ indicate placement of thermistors to measure fluid and surface temperatures.

FIG. 3 shows the growth of the deposit height with time for a 3% wax solution in two stress regimes: low stress (5-7 Pa, top curves) and high stress (60-90 Pa, bottom curves). The superposition of three replicate experiments for each stress level show the reproducibility of the measurements.

FIG. 4 shows the distribution of n-paraffins in the original solution (▴), in the deposit from the low shear stress case (◯), and in the deposit from the high shear stress case (□).

FIGS. 5(a) and 5(b) show the effect of polymer additives upon wax deposition, where FIG. 5(a) shows a low shear stress regime and FIG. 5(b) shows a high shear stress regime. For each regime, three replicate curves are shown for the case of no polymer addition. The deposit with the addition of PEB-7.2 led to erosion in the low shear stress case. In the high shear stress cases, the addition of PEB-7.2 led to a deposit that was high enough to create a pressure drop above the limit of the pressure transducer. The addition of 0.1% maleic anhydride copolymer (MAC) MAC 16-18 or of 0.05, 0.1, or 0.5% MAC Et22 prevented any deposition, and effects of 0.05, 0.1, or 0.5% polymer addition are indistinguishable.

FIGS. 6(a) and 6(b) show the effect of the addition of 0.1% PEB-7.2 upon the distribution of n-paraffins in deposited wax. Low and high shear stresses are shown in FIGS. 6(a) and (b), respectively. Curves were labeled as follows: original solution (▴), the deposit without polymer (▪), and the resulting deposit with 0.1% PEB-7.2 (□). The wax represented 11% of the low shear stress deposit and 41% of the high shear stress deposit, with the rest being liquid.

FIGS. 7(a) and 7(b) show the temperature field in the deposition cell in the low and high shear stress regimes calculated from the heat-transfer solution of McCuen (McCuen, P. A. Heat Transfer with Laminar and Turbulent Flow between Parallel Planes with Constant and Variable Wall Temperature and Heat Flux; Stanford University: Palo Alto, Calif., 1962). Each curve represents the temperature field across the height of the cell at specific axial locations, z, in centimeters. The beginning of the cooled deposition surface is given as z=0. The vertical line at 22.5° C. represents the cloud point of the 3% wax solution. Where this line crosses a given temperature field curve indicates the maximum height of the deposit, assuming no change in the temperature field with the presence of the wax deposit. The vertical line at 26° C. represents the cloud point of the wax solution with the addition of 0.1% PEB-7.2. Distortions in the curves at the shortest axial distances are due to the fact that more eigenfunctions are needed for accuracy at shorter axial distances.

FIG. 8 shows the growth of the deposit height with time for wax solutions with 0.1% MAC 16-18 added in the high shear stress regime. The top curve is for a wax solution with no polymer and a deposition surface temperature of 21.4° C. The bottom curve is for a solution with MAC 16-18 and a deposition surface temperature of 19.7° C. The middle curve is for a solution with MAC16-18 and a deposition surface temperature of 18.8° C. Jagged flat portions of MAC16-18 deposition curves correspond to an apparent steady-state balance of erosion and deposition.

FIG. 9 shows a gas chromatograph of the deposit from a test with 0.1% MAC 16-18 at 19.7° C. (□). The carbon-number distribution is shift down from the deposit with no polymer at a deposition surface temperature of 21.4° C. (▪). The paraffin distribution of the original 3% wax solution (▴) is also shown.

### DETAILED DESCRIPTION OF THE INVENTION

An in-depth understanding of the effects of polymer additives upon the rate, composition, and structure of paraffin deposition is required in the development of deep, off-shore oil fields to predict treatment strategies.

To this end, a new laboratory-scale deposition cell that enables the measurement of wax deposition under controlled shear stresses and thermal gradients is provided herein. A model oil with 3 wt % of a multicomponent wax was tested in a parallel-plate laboratory-scale deposition cell under laminar flow at low and high wall shear stress conditions (5-7 and 60-90 Pa, respectively).

The addition of 0.1 wt % of poly(ethylene butene) (“PEB”), which has been shown to reduce the yield stress of the gelled solution 10-fold, actually increased the initial deposition rate. However, the deposit eroded from the surface under low shear stress conditions, while the deposit remained intact under high shear stress conditions.

The addition of poly(maleic anhydride octadecene) modified with octadecyl amine and poly(maleic anhydride ethyl vinyl ether) modified with docosanyl amine each prevented deposition under similar conditions.

Results provide a consistent framework for understanding the role of polymer additives on deposition in terms of the temperature field above the deposition surface and the cloud point of the solution. Polymers that suppress wax nucleation and suppress the cloud point will prevent deposition if the surface temperature is above the cloud point. This is the case with poly(maleic anhydride octadecene) modified with octadecyl amine polymers. Polymers that prevent wax crystal aggregation by a colloidal stabilization mechanism but that do not suppress nucleation do not prevent deposition. PEB polymers fall in this class. However, these polymers can produce deposited layers with sufficiently low mechanical strength that layer thickness can be controlled by erosion.

The mechanism of erosion is demonstrated for the maleic anhydride copolymer. Results from gas chromatography and optical microscopy examine the composition and structure of the deposits.

The use of a small laboratory-scale deposition cell that operates under tightly controlled wall shear stress and temperature-gradient conditions that reflect actual pipeline operating conditions is provided herein. As a test of the apparatus, a well-characterized wax solution and several model wax-deposition control polymers are studied.

Accordingly, a new laboratory-scale flow cell to characterize wax deposition under realistic stress and thermal fields and is provided with which to examine the effect of polymers upon deposition. This builds on previous deposition studies and the experience with polymer modification of waxy gels.

A parallel-plate laboratory-scale deposition apparatus was constructed that allows visual observation of deposition. Tests were performed in two flow regimes: one at wall shear stresses typical of oil pipelines and one at higher shear stresses. Temperatures of the incoming oil and the cold deposition surface were controlled. Results were examined in terms of the growth of the deposit height, deposit composition, deposit morphology, and the temperature field inside the deposition cell.

Two polymer systems were studied. The first was based on poly(ethylene butene) (“PEB”), formed from polymerization of butadiene with a controlled ratio of 1,2-1,4 addition (Ashbaugh et al. (2002) Macromolecules, 35:7044-7053). Hydrogenation converts the polymer into a poly(ethylene) with well-defined crystallinity, because of the controlled number of side branches that result from 1,2 addition. In gelled solutions of a single long-chain n-paraffin, these PEB polymers reduced the yield stress over 3 orders of magnitude. In multicomponent waxy oils, such polymers provided 10-fold reductions in yield stress (Tinsley, J. F., Effect of polymer additives upon waxy deposits. In The 7th International Conference on Petroleum Phase Behavior and Fouling; Asheville, N.C., 2006). For the second polymer system, two copolymers of maleic anhydride were examined. The first was a copolymer of maleic anhydride and octadecene modified with an octadecyl amine (Guo et al. (2005) Prepr.-Am. Chem. Soc., Div. Pet. Chem., 50:318-320). Thus, this polymer had C16 and C18 alkyl appendages extending from the backbone. When the copolymer was added to waxy crude oils at concentrations of 0.1 wt %, it reduced the yield stresses up to 3 orders of magnitude and significantly reduced the size of the wax crystals. The second was a copolymer of maleic anhydride with ethyl vinyl ether. Amidation with docosanyl amine appended C22 alkyl tails to the backbone. The results presented here show the effects of three separate polymers upon the deposition of a model oil with a multicomponent wax.

Accordingly, the instant invention provides methods of reducing wax deposition from a petroleum product during transmission of the petroleum product, such as through a pipeline. The methods include the mixing with the petroleum product (e.g., crude petroleum) at least one maleic anhydride copolymer. In a particular embodiment, the polymer selected from the group consisting of: a poly(maleic anhydride-co-α-olefin) modified with long chain alkyl amines; a poly(maleic anhydride-co-alkyl vinyl ether) modified with long alkyl amines; and poly(maleic anhydride-co-styrene) modified with long chain alkyl amines. In a particular embodiment, the long chain alkyl amine comprises at least 10 carbons, at least 12 carbons, from 12 to 30 carbons, or, more particularly, 18-24 carbons. In another embodiment, the alkyl of the alkyl vinyl ether is a lower alkyl (i.e., contains 1 to 4 carbons). In a particular embodiment, the alkyl of the alkyl vinyl ether is ethyl. In yet another embodiment, the styrene group may be replaced by another aryl containing moiety such as aryl moiety linked to the polymer backbone via an alkyl group (e.g., a lower alkyl).

The term “alkyl,” as employed herein, includes hydrocarbons containing about 1 to about 40 carbons which are straight or branched and/or saturated or unsaturated and which may be substituted (for example, with 1 to 4 substituents (e.g., halogen, alkyl, alkoxy, hydroxy, aryl, aryloxy, aralkyl, cycloalkyl, alkylamido, alkanoylamino, oxo, acyl, arylcarbonylamino, amino, substituted amino, nitro, cyano, thiol and/or alkylthio). In a particular embodiment, the alkyl is a straight, saturated hydrocarbon which is not substituted.

The following examples are provided to illustrate various embodiments of the present invention. The examples are illustrative and are not intended to limit the invention in any way.

### EXAMPLE I

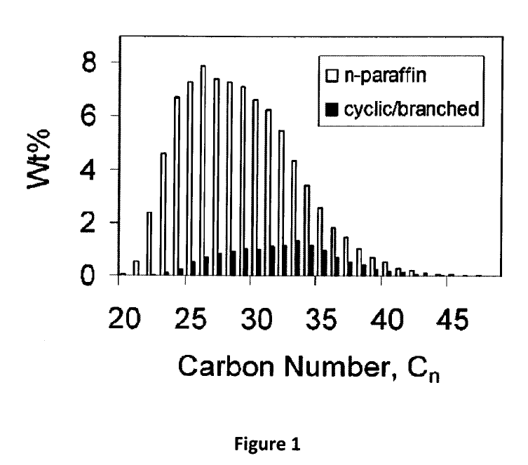

Samples. All tests used a 3.0 wt % solution of multicomponent wax whose continuous carbon-number distribution ranges from C20 to C47 as shown in FIG. 1. The wax was a blend of two waxes from Aldrich: 55 wt % Aldrich number 327204 with a melting point from 53 to 57° C. and 45 wt % Aldrich number 411663 with a minimum melting point of 65° C. The higher melting point wax provides a significant amount of heavier paraffins, which are the primary components of waxy deposits. Furthermore, it has a nearly log-normal distribution of paraffins with carbon numbers greater than 30 carbons (C30), which is typical for commercial crude oils (Paso et al. (2003) AIChE J., 49:3241-3252). Finally, it should be noted that there is a critical carbon number, normally between C20 and C30, for which longer paraffins diffuse into the deposit over time and shorter paraffins diffuse out of the deposit, leading to a process called aging (Singh et al. (2001) AIChE J., 47:2111-2124). To observe the effects of aging, the wax distribution covers this range of carbon numbers. The solvent used was Norpar12 Fluid (ExxonMobil Corporation), a mixture of normal alkanes from C10 (decane) to C14 (tetradecane). The separation in carbon number between the solvent and wax allows the amount of wax in the deposit to be easily differentiated from the liquid content by means of gas chromatography (“GC”).

A random copolymer of PEB was prepared as previously described (Ashbaugh et al. (2002) Macromolecules, 35:7044-7053). The degree of side branching was characterized by ¹H NMR of the unhydrogenated polymer and showed that the polymer had an average of 7.2 side branches per 100 backbone carbons. The hydrogenated polymer is thus labeled PEB-7.2. The weight-average molecular weight (M_{w}) and polydispersity index (M_{w}/Mₙ) of the polymer are 4,900 and 1.06, respectively.

Two copolymers of maleic anhydride (MAC) were tested. The first, called MAC16-18, was prepared by amidation of poly(1-octadecene-co-maleic anhydride) with octadecylamine and had a molecular weight of M_{w}=12,300 with a polydispersity index of 1.4. Further details of the preparation and characterization are provided elsewhere (Guo et al. (2005) Prepr.-Am. Chem. Soc., Div. Pet. Chem., 50:318-320). The second maleic anhydride copolymer, denoted MAC Et22, was prepared by amidation of poly(maleic anhydride ethyl vinyl ether). The details of the synthesis and characterization are presented hereinbelow. The weight-average molecular weight and polydispersity index of the MAC Et22 were 146,000 and 1.26, respectively, as measured by light scattering.

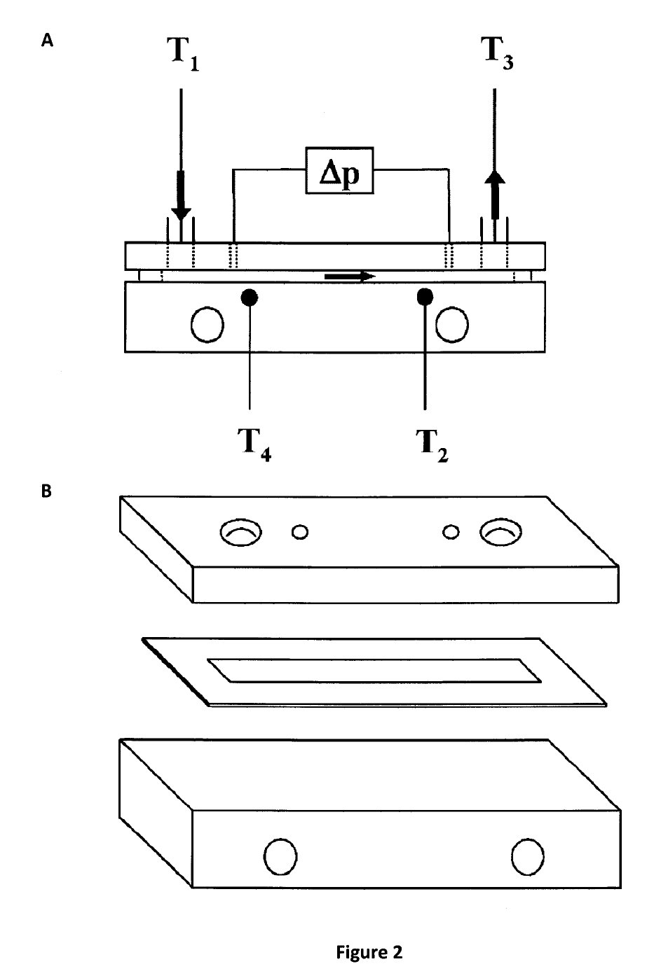

Deposition Cell. Deposition tests were performed by passing warm wax solution over a cold surface. A parallel-plate geometry was used as show in FIGS. 2(a)-(b). The lower surface was a copper plate approximately 7×20×2.5 cm that was plated with 0.0005 in. electroless nickel (New Brunswick Plating, Inc., New Brunswick, N.J.). To ensure uniform smoothness across the surface, 320 and 600 grit lapping compounds were applied. The upper surface was a polymethyl methacrylate (PLEXIGLAS®) plate approximately 2 cm thick. The channel for flow was formed by a spacer that was either 0.18 or 0.48 mm thick. Cooling water passed through the bottom plate lowered the temperature of the surface to induce deposition. The upper plate was insulating and did not accumulate a deposit. The spacers were made from die-cut polytetrafluoroethylene (TEFLON®) or machined brass shim stock.

Oil was passed through the upper plate, over the deposition surface, and out through the upper plate at the other end. Pressure taps placed over the flow path measured the differential pressure during deposition. The increase in pressure was related to a change in the average channel height. Differential pressure measurements were made with a Honeywell ST3000 Smart Pressure Transducer, model number STD-125, which had a maximum range of 0-600 in. H₂O. The pressure taps were 10 cm apart, and the deposition channel was 2 cm wide. There was 3.2 cm between the oil entrance and the first pressure tap to allow for fully developed flow between the pressure taps. The surface for this entry length was thermally insulated by installation of a 0.6 cm deep layer of cured solvent-resistant epoxy (EP42LV from Masterbond, Hackensack, N.J.). This prevented deposition in the hydrodymanic entry length. The total area available for deposition was 23.8 cm². Thermistors measured the temperature of the oil entering and leaving the cell (T₁ and T₃ in FIG. 2(a)). The temperature of the deposition surface was measured by two thermistors placed 0.23 cm below the surface under the pressure taps (T₂ and T₄ in FIG. 2). After the test, the cell was disassembled and deposit samples were removed from the surface with a thin piece of biaxially-oriented polyethylene terephthalate (MYLAR®) for analysis by GC and microscopy.

An external loop consisted of a section to reheat the wax solution to fully dissolve any precipitated wax, a pump, and a heat exchanger to bring the waxy oil entering the cell to a specified temperature. The solution was reheated by passing it through a 5 ft 4 in. length of a ⅛ inch inner diameter stainless steel tubing in an oil bath followed by a 500 mL heated reaction kettle. The pump was an Ismatec MCP-Z gear pump (Glattbrugg, Switzerland) with a 0.92 mL/rev PEEK pump head (Micropump, Vancouver, Wash.). Before the wax solution entered the deposition cell, it passed through a final heat exchanger consisting of 18 feet of a ⅛ inch stainless steel tubing bent multiple times to fit inside a Lauda RMS temperature bath. The tubing connecting this heat exchanger to the deposition cell was insulated. The temperature of the incoming wax solution required control to within ±0.1° C. in order to obtain reproducible results. All connecting flow lines were ⅛ inch inner diameter polytetrafluoroethylene (TEFLON®) tubing, except those directly connected to the flow cell, which were TYGON® F-4040 fuel tubing. The polytetrafluoroethylene (TEFLON®) fittings from Swagelok (Huntingdon Valley, Pa.) were attached to the deposition cell to aid in thermal insulation. All other fittings were stainless steel Swagelok fittings.

GC. GC was performed on a Hewlett-Packard 6890 Series II gas chromatograph with a flame ionization detector and a 30 m AT-5 column with a 0.32 mm inner diameter and a 0.25 mm film thickness (Alltech Associates, Deerfield, Ill.). The flow rate of helium carrier gas through the column was approximately 0.8 mL/minute, and a 5 m guard column was used to capture polymers. Injector and detector temperatures were 330 and 350° C., respectively, and the oven temperature was programmed to hold at 40° C. for 1 minute, ramp to 330° C. at 10° C./minute, and then hold, typically for 50 minutes. Tracers of octacosane and hexatriacontane were used to match elution times with the carbon number. Replicate experiments showed a precision of approximately ±3.5% in the wax concentration measurement.

Microscopy. Samples were placed on a microscope slide and covered with a cover slip. Microscopic examination was performed in transmission with cross-polarization optics. Objectives used were as follows, all from Carl Zeiss (Oberkochen, Germany): Plan Neofluar 10× with a 0.30 numerical aperture, Epilan 20× with a 0.40 numerical aperture, and LD Acroplan 40× with a 0.60 numerical aperture and color correction for the cover slip. Images were captured with a Carl Zeiss Axiocam HRc camera using Carl Zeiss Axiovision 3.1 software.

Cloud Point. The precipitation temperatures of the wax solutions (i.e., the cloud point) were measured by the onset of turbidity. The 3% wax solution without a polymer was placed in a disposable culture tube, capped, and heated to 90° C. to fully dissolve the wax. The tube was then placed in a water bath at 30° C. After 30 minutes, the onset of turbidity was observed by use of a laser pointer. If sufficiently large particles had precipitated, scattering in the sample would make the beam visible inside the culture tube. This method was more sensitive to the onset of turbidity than visual observation of a hazy appearance. The sample was removed from the water bath long enough for observation (less than 15 seconds) and did not precipitate while in the air. After observation, the temperature was lowered by 0.5° C. and the sample was observed again after 30 minutes. This process was repeated until the onset of turbidity was observed. A similar procedure was used for waxy solutions with added polymer. In this case, the laser pointer was again used to observe the cloud point but the temperature intervals were modified so that the smaller intervals occurred near the cloud point of the 3% wax solution tested above. The temperature intervals were as follows, all in degrees Celsius: 60, 50, 40, 30, 26, 25, 24, 23, 22, 21, 20, 19, and 18.

### Results

Deposition with No Polymer. Deposition experiments were performed in two flow regimes to examine the effects of wall shear stress. Export lines for crude oil where paraffin deposition occurs typically operate at wall shear stresses around 1-10 Pa. As Table 1 shows, the low flow regime used in these experiments fell into this range. Tests at very high wall shear stresses were also performed to investigate the effects of polymer additives, which were known to reduce yield stress. The increase in wall shear stress was achieved not only by increasing the flow but also by using a thinner spacer, because the wall shear stress is inversely proportional to the third power of the height of the channel. All tests were under laminar flow conditions.

TABLE 1
Conditions for “Low” and “High” Shear Stress
Regimes Used in Deposition Tests

| | “low” wall shear stress | “high” wall shear stress |
|---|---|---|
| flow rate (mL/min) | 185 | 325 |
| channel height (mm) | 0.48 | 0.18 |
| Reynolds number | 180 | 320 |
| wall shear stress (Pa) | 5-7 | 60-90 |

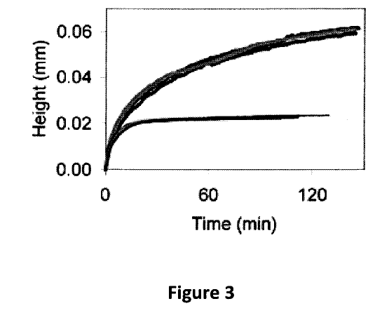

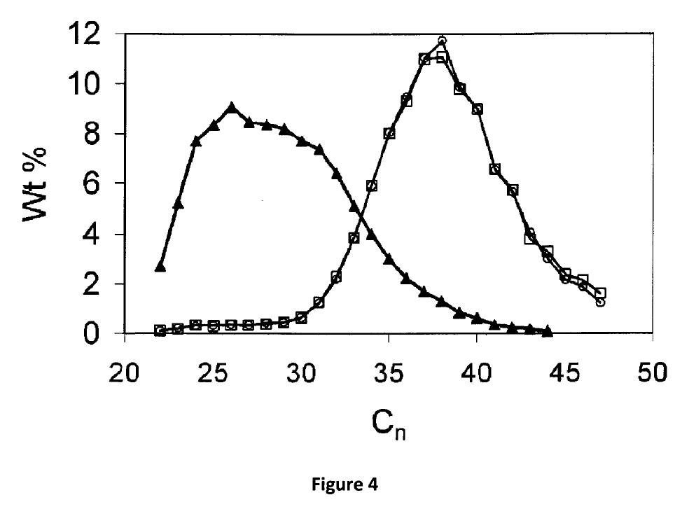

The growth of the deposit height with time is shown for both regimes in FIG. 3. The high shear stress test quickly reaches a maximum height, while the lower shear stress regime rises more gradually to a higher value. GC shows that the deposit for both cases is enriched in longer n-paraffins and contains more wax than the solution: 41% wax for the low shear stress case and 46% wax for the high shear stress case. FIG. 4 shows the shift in normal paraffin distribution. Such behavior follows the trends of similar deposition tests (Parthasarathi et al. (2005) Energy Fuels, 19:1387-1398; Singh et al. (2000) AIChE J., 46:1059-1074). All tests were run with the temperature of the copper plate at 21.4° C. according to the thermistor furthest from the oil inlet (T₂ in FIG. 2(a)). The temperature of the oil inlet (T₁) was about 30.0° C. for the low shear stress case and 30.4° C. for the high shear stress case.

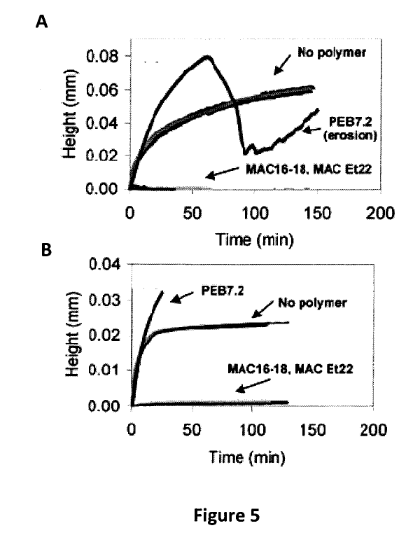

Effect of Polymers. The effect of polymer additives is shown in FIGS. 5(a)-(b). All polymers were added at 0.1 wt %, except for MAC Et22, which was also added at 0.05 and 0.5 wt %. The MACs, MAC Et22, and MAC16-18, prevented deposition from occurring.

The addition of PEB-7.2 led to an increased deposition rate in both the high and low shear stress regimes. In the low shear stress regime, the deposit started to erode after 60 minutes, indicated by a drop in the average deposit height in FIG. 5(a). Visual observation during that time showed that large sections of deposited wax broke off from the surface at the front of the deposition cell. As time progressed, the erosion moved further down the deposition surface until the initial deposit had entirely eroded at 92 minutes. As another section of the deposition surface was exposed, a new section of deposit was started, leading to the growth of a deposit with a patchwork appearance. In the high shear stress regime, the addition of PEB-7.2 led to the growth of a deposit whose pressure drop exceeded the upper limit of the pressure transducer (FIG. 5(b)). The increased deposition rate was not accompanied with erosion, confirmed by visual observation of the surface after 2 hours of testing.

At first, it is surprising that erosion occurred in the low shear stress case instead of the high shear stress case. Tests on a controlled stress rheometer showed that the yield stress of a 3% wax solution with 0.1% PEB-7.2 is 17±3 Pa. Thus, if the wall shear stress was above this value, one would expect the deposit to erode. However, the wall shear stresses were below this value in the low flow regime (5-7 Pa), and they were above this value in the high flow regime (60-90 Pa). It should be noted that the deposit is expected to have a higher wax content and also different thermal and shear histories than the Theological sample, and thus, ultimate yield stress would be different (Venkatesan et al. (2005) Chem. Eng. Sci., 60:3587-3598). However, the value of yield stress observed on the rheometer can serve as a reference point.

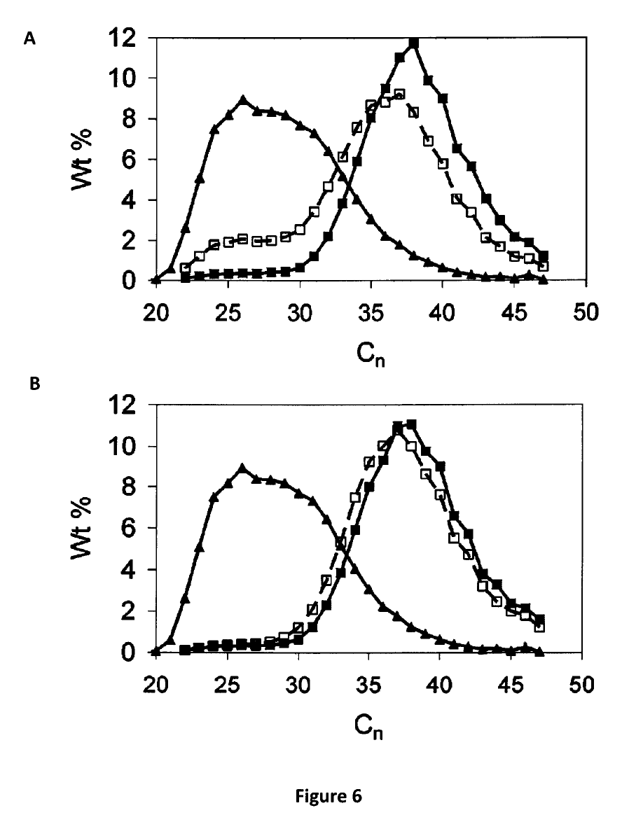

Examination of the deposits by GC and microscopy shed light on the unexpected deposition results with PEB-7.2. Carbon-number distributions provided in FIGS. 6(a)-(b) lead to several interesting observations. First, the amount of solid wax in the deposit was significantly reduced from 41% (no polymer) to 11% (with PEB-7.2) in the low stress case. Second, the carbon-number distribution of the deposited material shifted down upon the addition of PEB-7.2. The peak in the distribution moved from Cₙ=38 to 36 with the PEB polymer. Third, micrographic results show that PEB-7.2 reduced the wax crystal size in the deposit most significantly in the low shear stress case. Thus, the gel in the low shear stress case had less wax and smaller crystals. It should be noted that the erosion appeared to be due to adhesive failure between the wax and the deposition substrate and not due to a cohesive failure similar to yield stress.

Cloud Point. The cloud point is expected to be important in the deposition process. When a warm waxy oil is passed over a cold surface, a temperature gradient is established, extending from a minimum temperature at the cold surface to a maximum temperature in the bulk. If the temperature of the bulk oil is above the cloud point and the cold surface is below the cloud point, the maximum height of a deposit is expected to be the height at which the temperature in the field equals the cloud point (Singh et al. (2000) AIChE J., 46:1059-1074). Above this height, the waxy oil is warm enough to dissolve solid wax.

The addition of a polymer alters the cloud point of the waxy solution as shown in Table 2. The addition of MAC Et22 or MAC16-18 lowers the cloud point below the temperature of the deposition surface (21.4° C.). Thus, the lack of deposition for these polymers can be accredited to the fact that the polymer prevented significant precipitation. However, the addition of PEB-7.2 increased the cloud point.

TABLE 2
Effect of Polymers upon the Cloud Point

| polymer | wt % polymer | cloud point (° C.) |
|---|---|---|
| | 0 | 22.5 |
| MAC16-18 | 0.1 | 21.0 |
| MAC Et22 | 0.05 | 19.0 |
| MAC Et22 | 0.1 | 21.0 |
| MAC Et22 | 0.5 | 21.0 |
| PEB-7.2 | 0.1 | 26 |

The parallel-plate geometry used in these experiments can be modeled as a laminar flow between two infinite plates, one of which is isothermal and another of which is adiabatic. The temperature difference between the thermistors in the front and back of the deposition cell was typically 0.1° C. or less, allowing the surface to be approximated as isothermal. The channel can be modeled as infinitely wide because the ratio of the width to height is sufficiently high, so that the velocity profile of only a very small portion of the channel is disturbed by the side walls (Deen, W. M., Analysis of Transport Phenomena; Oxford University Press: New York, 1998). For the deepest channel used in the work presented here, this ratio is 40. The heat-transfer model for such a parallel-plate system has been solved by McCuen, allowing for the calculation of the temperature field inside the deposition cell (McCuen, P. A. (1962) supra).

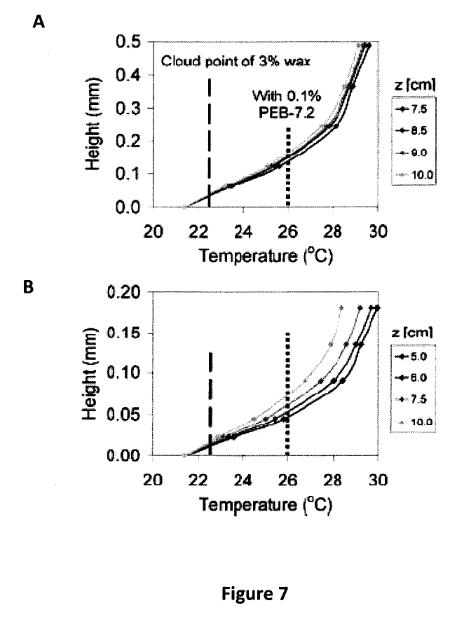

The temperature field calculated from McCuen's model can be compared with the experimentally measured cloud point to determine an expected maximum deposit height. This estimate for the deposit height can then be compared with the height observed in deposition experiments. FIGS. 7(a)-(b) show the temperature field calculated from the McCuen solutions along with the effect of changing the cloud point. The temperature across the height of the deposition channel is plotted for a series of different axial positions from the entrance. Graphs are shown for both the high and low flow regimes. The intersection of the temperature field (curves) with the cloud point (vertical line) shows the maximum deposit height that is expected. At vertical locations above this intersection, the temperature is high enough to prevent deposition. According to FIGS. 7(a)-(b), the cloud point of the wax solution without any polymer limits the height of the deposit to about 0.04 mm for the low shear stress regime and to nearly 0.02 mm for the high shear stress regime. For the high shear stress case, 0.02 mm corresponds well to the maximum height observed in FIG. 3. Note that this height represents an average calculated from the pressure drop over the length of the deposition cell. For the low shear stress case, the actual observed height is above that predicted from the temperature field (0.06 mm observed). However, the temperature field does not account for the wax deposit, and the thick layer of wax likely provides insulation, so that the temperature drop across the deposit was smaller. Indeed, the insulating effect of the deposit was experimentally observed, because the temperature of the oil exiting the flow cell increases with the thickness of the deposit. Therefore, the height of the deposit can be related to the location of the cloud point in the temperature field of the deposition cell.

Furthermore, increasing the cloud point by the addition of PEB-7.2 creates a thicker deposit. In FIGS. 7(a)-(b), this is seen in the shift of the vertical cloud point line to the right, which in turn allows a higher deposit to form. These results cannot be quantitatively compared to experimental results in FIG. 3, because erosion occurred (in the low shear stress case) or because the ultimate deposit height was above the upper limit permitted by the pressure transducer (for the high shear stress case). However, in both cases, the initial growth of the deposit with PEB-7.2 exceeded that without a polymer. Thus, the increase in the deposition rate with PEB-7.2 can be interpreted as simply a natural consequence of increasing the cloud point in the same temperature field.

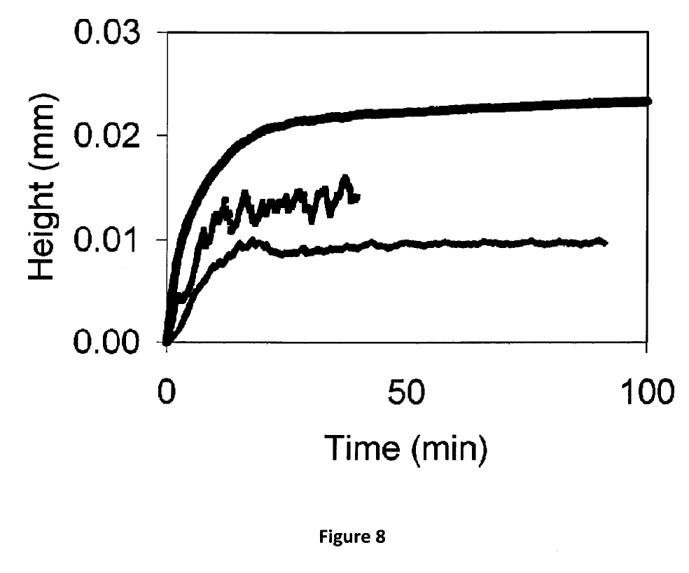

MAC16-18 below the Cloud Point. To observe deposition with one of the MACs, the temperature of the deposition surface was decreased well below the cloud point of the polymer and wax solution. FIG. 8 shows the deposition results for tests with 0.1% MAC16-18 performed in the high shear stress regime at two temperatures. In these cases, the average height of the deposit quickly reaches an equilibrium height of 0.010 mm. Visual observation of the surface showed that the deposit stopped growing when significant erosion started for the test run at a deposition surface temperature of 19.7° C. The apparent steady-state appearance of the deposit for this test was a fingered pattern. At a lower temperature of 18.8° C., a similar erosion phenomenon was observed.

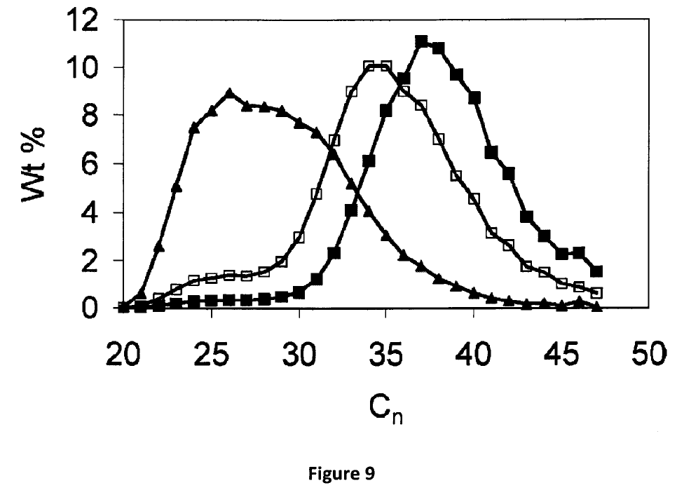

Analysis of the deposit by GC showed that the addition of MAC16-18 shifted the distribution of n-paraffins down about 3 carbon numbers, similar to the effect of PEB-7.2 (FIG. 9). The wax content for this sample was 20%. Microscopic observation of the deposit sample showed that the size of the crystal domains was significantly reduced by the addition of MAC16-18. Whereas the addition of 0.1% PEB-7.2 at high wall shear stresses reduced the size of the crystal domains to about 5 μm, the addition of 0.1% MAC16-18 reduced the size of the crystal domains to less than 3 μm. However, the faster cooling rate caused by the lower plate temperature may also be responsible for smaller crystal sizes (Venkatesan et al. (2005) Chem. Eng. Sci., 60:3587-3598).

A small-scale parallel-plate deposition cell has been constructed that enables studies of wax deposition under controlled conditions of wall shear stress and cooling rates representative of field conditions. This deposition cell is capable of high wall shear stresses under laminar flow and allows visual observation of deposited layers.

Tests were performed at high and low wall shear stresses with the addition of three different polymer additives, two of which were shown to reduce yield stresses of waxy gels (Tinsley, J. F. (2006) supra; Guo et al. (2005) Prepr.-Am. Chem. Soc., Div. Pet. Chem., 50:318-320).

For a deposition surface temperature of 21.4° C., the addition of PEB-7.2 increased the deposition rate, while the addition of MAC Et22 and MAC16-18 prevented deposition. This shows the complex interplay between molecular diffusion of paraffin to a surface layer versus nucleation and growth in bulk. The role of polymers is different for each case. The change in the deposition rate for all of the polymers is related to the cloud point in the temperature field near the surface. The PEB polymers co-crystallize with wax and suppress particle interactions and bulk gelation, as previously demonstrated (Ashbaugh et al. (2002) Macromolecules, 35:7044-7053; Guo et al. (2006) Energy Fuels, 20:250-256). However, they do not suppress the cloud point (Tinsley, J. F. (2006) supra). They provide colloidal stabilization of wax particles that are formed but do not provide thermodynamic suppression of nucleation. In contrast, MAC polymers depress the cloud point, which indicates the suppression of nucleation. The suppression of nucleation in bulk occurs concomitantly with a suppression of the addition of wax to surfaces. The deposition was observed in tests with MA16-18 below the cloud point of the polymer plus wax solution. These results indicate the benefit of detailed modeling of the combined thermal and flow fields during wax deposition. The solution of the thermal and flow fields without deposition has been used to provide estimates of the distances from the surface at which the cloud point will occur.

The second major observation is that, even in the presence of deposition, wall shear stresses may be great enough to erode the deposited layer. In this case, the influence of polymers upon reducing the yield stress of bulk wax gels does correspond to the ability to limit gel-layer thicknesses by mechanical erosion. However, the exact value of the yield stress of the bulk gel is not necessarily equal to the shear stress that will erode a wax layer at a surface. The difference is that the deposited wax layer may have a different wax content than the bulk fluid. The mechanical properties of the wax layer also depend upon the shear and temperature fields in which the deposit was formed (Singh et al. (1999) J. Rheol., 43:1437-1459; Venkatesan et al. (2005) Chem. Eng. Sci., 60:3587-3598). As demonstrated with the PEB-7.2, erosion was observed in the low shear stress regime, while the stresses required for erosion were greater for deposits formed under higher shear rate conditions.

Additional effects of polymer additives were observed on the deposits. The size of the wax crystal domains was reduced, most significantly in the cases where erosion was observed with PEB-7.2 at low shear stresses and with MAC16-18. For MAC16-18, crystal size reduction may also be related to the faster cooling from the colder deposition surface. The wax content was decreased, and the distribution of n-paraffins was shifted down for the deposits upon the addition of the polymer. This change was greatest for deposits where erosion was present, namely, the PEB-7.2 in the low shear stress regime and MAC16-18. This suggests that the crystalline polymers may help stabilize the longer paraffins in solution. Alternatively, an eroding deposit exposes a fresh surface, allowing for the deposition of lower molecular-weight alkanes, which would otherwise be removed by aging (Singh et al. (2000) AIChE J., 46:1059-1074).

### EXAMPLE II

Synthesis and Subsequent Modification Maleic Anhydride Co-Polymerized with Styrene and with Vinyl Ethyl Ether via RAFT Polymerization

Materials. Carbon disulfide was obtained from Aldrich Chemical Company and distilled from MgSO₄ prior to use. Diethyl ether and THF were of anhydrous grade from Aldrich Chemical Company. Mg° was obtained from Aldrich as thin shavings that were washed three times with 0.05M HCl, rinsed with water and then acetone and dried under vacuum. Maleic anhydride was obtained from Fisher Baxter Scientific and recrystallized from dry benzene and vacuum dried prior to use. Bromobenzene, ethylvinyl ether, AIBN and LiAlH₄ were obtained from Aldrich Chemical Company and used as received. Behenamide was obtained from TCI America and used without further purification.

Instrumentation. NMR analyses (¹H and ¹³C) were performed using a Bruker Avance 300 MHz NMR. Gel Permeation Chromatography was performed by Halliburton Energy Services Analytical Group using Waters GPC pumps, Polymer Laboratories columns and a Wyatt Technologies DAWN multiangle laser light scattering detector. The mobile phase for GPC analysis was THF at a flow rate of 1 mL/minute. Infrared spectra were obtained using a Nicolet 6700 FTIR with an ATR attachment.

### Dithiobenzoic Acid, 9355-09

To a mixture of Mg° (3.41 g, 0.142 mol) in diethyl ether (90 mL), bromobenzene (22.18 g, 0.1420 mol) was added dropwise over a period of several hours under inert atmosphere. After the addition was complete, the mixture was heated at reflux for 4 additional hours and then cooled to ambient temperature. Carbon disulfide (25 mL) was added dropwise over 2 hours and the resulting mixture stirred for an additional 8 hours. The reaction was then quenched by the addition of water (200 mL) and the organic layer removed. The aqueous layer was washed twice with diethyl ether (100 mL) and the aqueous layer then acidified with HCl (conc.). Dithiobenzoic acid was extracted from the aqueous layer by two washings with diethyl ether (100 mL) and ether washings were combined. The dithiobenzoic acid was then extracted from the organic phase with 10% NaOH (aq.) (250 mL). The aqueous extract was acidified with HCl (aq., conc.) and the dithiobenzoic acid again extracted with diethylether (150 mL). The ether layer was removed under reduced pressure and the residue dried under vacuum over night to give dithiobenzoic acid as dark red liquid. Yield: 12.25 g (56%). ¹H NMR (300 MHz, CDCl₃): δ 8.21 (d, J=7 Hz, 2H), 7.3-7.6 (m, 4 H), plus small amounts of biphenyl and other minor impurities. ¹³C NMR (75 MHz, CDCl³): δ 225.43, 143.31, 133.23, 128.63, 126.76 (additional signals from biphenyl and other minor impurities).

I-Phenylethyl benzodithioate, 9355-13 (Chong et al. (2003) Macromolecules, 36:2256-2272)

A solution of CCl₄ (25 mL), dithiobenzoic acid (9.01 g, 58.4 mmol) and styrene (16.36 g, 157.1 mmol) was heated to reflux for several hours until TLC showed the complete consumption of dithiobenzoic acid (alumina, Pet. Ether (20-40° C.)). The solvent was removed under reduced pressure and the residue dried under high vacuum at ambient temperature overnight. The remaining residue was then subjected to column chromatography (alumina, neutral, Pet. ether (20-40° C.)) to give 1-phenylethyl benzodithioate as a dark red liquid. Yield: 10.11 g (67%). ¹H NMR (300 MHz, CDCl₃): δ 8.03 (d, J=6.6 Hz, 2H), 7.29-7.47 (m, 8H), 5.31 (q, J=7.1 Hz, 1H), 1.86 (d, J=7.1 Hz, 3H). ¹³C NMR (75 MHz, CDCl₃): δ 226.60, 144.84, 141.15, 132.18, 128.55, 128.16, 127.72, 127.58, 126.82, 50.13, 20.67. IR (Neat): 3059.6, 3027.7, 2966.9, 2923.6, 2862.8, 1590.0, 1491.7, 1444.4, 1227.5, 1042.3, 876.5, 762.7, 699.0 cm⁻¹.

### Docosanylamine, 9355-29 (Smith, M. B., “Organic Synthesis”, 1st ed., McGraw-Hill Science, New York, 1994)

A mixture of behenamide (80.08 g, 0.236 mol) in THF (500 mL) was gently warmed to effect complete dissolution of the solid. The mixture was cooled to 30° C. and a suspension of LiAlH₄ (15.26 g, 0.402 mol) in THF (100 mL) was added dropwise over the course of 1 hour. The mixture was stirred at 30° C. for 1 hour and then heated under reflux conditions for an additional 50 hours. The mixture was cooled to 0° C. and water (200 mL) added slowly with vigorous stirring. The mixture was allowed to stand for 24 hours to solids removed by filtration. The solid was then recrystallized from dodecane and vacuum dried at 100° C. to give docosanylamine as a tan solid. Yield: 50.54 g 65.7%). ¹H NMR (CDCl₃, 300 MHz): δ 2.73 (t, J=7.2 Hz, 2H), 1.25-1.50. (br., ¹³C NMR (CDCl₃, 75 MHz): δ 42.03, 33.41, 31.93, 29.66, 29.49, 29.35, 26.90, 22.67, 14.05. IR (Neat): 2915.9, 2848.4, 1577.5, 1463.7, 719.3 cm⁻¹.

Poly(styrene-alt-maleic anhydride), 9355-15 (de Brouwer et al. (2000) J. Polym. Sci.: Part A: Polym. Chem., 38:3596-3603)

A solution of styrene (30.98 g, 297.4 mmol), maleic anhydride (29.17 g, 297.4 mmol), AIBN (698 mg, 4.26 mmol) and S-(2-phenethyl) dithiobenzoic acid (2.19 g, 8.49 mmol) in THF (114.3 g) was degassed with Ar for 30 minutes in a Schlenk flask. The flask was stoppered tightly with a head of Ar and placed in a 60° C. oil bath for 11.75 hours with samples taken at 4.5 and 9 hours. At the conclusion of the reaction, the flask was cooled to ambient temperature and opened to the air. The polymer was precipitated by slowly pouring the read solution into 2 volumes of cold diethyl ether. The polymer was fully dispersed and removed by filtration and vacuum dried to give poly(styrene-alt-maleic anhydride) as a light pink polymer, 49.1 g, 78.7% yield (conversion). ¹H NMR (300 MHz, CDCl3/DMSO-d6): δ 6.0-7.6 (br, 5 H), 2.8-3.8 (br, 3H), 1.6-2.8 (br, 2 H). ¹³C NMR (75 MHz, CDCl3/DMSO-d6): 6170-174 (br, C═O), 126-128 (br, aromatic C), 48-52 (br), 30-35 (br).

Poly(ethyl vinyl ether-a-maleic anhydride), 9355-19 (de Brouwer et al. (2000) J. Polym. Sci.: Part A: Polym. Chem., 38:3596-3603)

A solution of ethylvinyl ether (25.46 g, 0.3531 mol), maleic anhydride (31.96 g, 0.3261 mol), AIBN (0.754 g, 4.54 mmol) and 1-phenylethyl benzodithioate (2.250 g, 8.71 mmol) in THF (115.8 g) was degassed with Ar for 30 minutes in a Schlenk flask. The flask was stoppered tightly with a head of Ar and placed in a 60° C. oil bath for 20 hours with samples taken at 3 and 6 hours. At the conclusion of the reaction, the flask was cooled to ambient temperature and opened to the air. The polymer was precipitated by slowly pouring the read solution into 2 volumes of cold diethyl ether. The polymer was fully dispersed and removed by filtration and vacuum dried to give poly(ethylvinyl ether-alt-maleic anhydride) as a light pink polymer, 47.71 g, 83% yield (conversion).

Hexylamine modified 9355-15, 9355-16 (Smith, M. B. (1994), supra)

A solution of 9355-15 (13.330 g) and hexylamine (6.683 g) in THF (130 mL) was heated at reflux for 28 hours. The solution was cooled to ambient temperature and the solvent removed under reduced pressure and further vacuum dried over night. Yield: 19.427 g (97%).

Dodecylamine Modified 9355-15, 9355-17 (Smith, M. B. (1994), supra)

A solution of 9355-15 (10.46 g) and dodecylamine (9.566 g) in THF (90 mL) was heated at reflux for 29 hours. The solution was cooled to ambient temperature and the solvent removed under reduced pressure and further vacuum dried over night. Yield: 19.624 g (98%)

Docosanylamine Modified 9355-15, 9355-34 (Smith, M. B. (1994), supra)

A solution of 9355-15 (9.71 g) and 9355-29 (15.65 g) in THF (100 mL) was heated at reflux for 22 hours. The solution was cooled to ambient temperature and the solvent removed under reduced pressure and the solid further vacuum dried over night at 220° F. and 1.5 torr. Yield: 18.22 g (72%).

Hexylamine modified 9355-19, 9355-20 (Smith, M. B. (1994), supra)

A solution of 9355-19 (12.52 g) and hexylamine (7.46 g) in THF (90 mL) was heated at reflux for 17 hours. The solution was cooled to ambient temperature and the solvent removed under reduced pressure and further vacuum dried over night. Yield 19.14 g (96%).

Dodecylamine Modified 9355-19, 9355-21 (Smith, M. B. (1994), supra)

A solution of 9355-19 (9.61 g) and dodecylamine (10.46 g) in THF (100 mL) was heated at reflux for 17 hours. The solution was cooled to ambient temperature and the solvent removed under reduced pressure and further vacuum dried over night. Yield: 18.57 g (93%).

Docosanylamine Modified 9355-19, 9355-35 (Smith, M. B. (1994), supra)

A solution of 9355-19 (8.77 g) and 9355-29 (17.27 g) in THF (100 mL) was heated at reflux for 21 hours. The solution was cooled to ambient temperature and the solvent removed under reduced pressure and the solid further vacuum dried over night at 220° F. and 1.5 torr. Yield: 20.19 g (77%).

### Results

Synthesis of RAFT agent, 9355-13.

The RAFT agent needed for this was obtained in two steps by treatment of the Grignard of bromobenzene with carbon disulfide to give the phenyldithiobenzoic acid. This was then treated with excess styrene in carbon tetrachloride to give the desired 1-phenylethyl benzodithioate (9355-13), Scheme 1 (Chong et al. (2003) Macromolecules, 36:2256-2272).

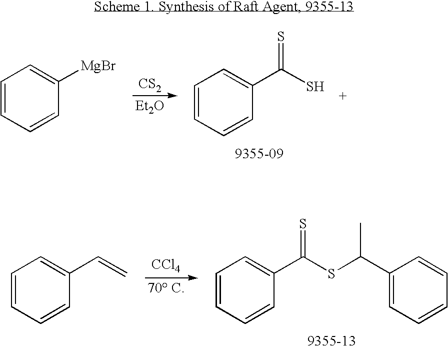

### Synthesis of Docosanvlamine, 9355-29.

Due to the lack of commercial sources of pure docosanylamine (C₂₂H₄₅NH₂), the compound was prepared in the lab by the reduction of commercially available behenamide (C₂₁H₄₃CONH₂) by reduction with LiA1H₄ in THF (Smith, M. B. (1994), supra). The separation of the amide from the amine was predicted to be difficult so the reaction was carried for 50 hours to ensure the complete reduction of the amide, Scheme 2. Characterization of the 9355-29 shows no indication of the presence of a carbonyl group by IR spectroscopy or ¹³C NMR spectrometry.

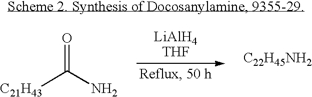

### Synthesis of Alternating Copolymers, 9355-15 and 9355-19.

Copolymers of maleic anhydride and styrene (9355-15) and maleic anhydride and ethylvinyl ether (9355-19) were obtained by the RAFT copolymerization of either styrene or ethylvinyl ether with maleic anhydride in THF with 9355-13 as the chain length control agent, Scheme 3 (de Brouwer et al. (2000) J. Polym. Sci.: Part A: Polym. Chem., 38:3596-3603). Previous experience demonstrated that in the absence of a control agent, the polymerization at 60° C. was complete after four hours. With the RAFT agent present, the rate of polymerization was significantly retarded, which is consistent with the mechanism of RAFT using the agent employed. The conditions employed used an initiator to RAFT agent ratio of 1:2 and a RAFT agent to monomer ratio of 70:1. This ratio was chosen to give a polymer chain of approximately 7000 Daltons at 100% conversion. The measured conversions were 78 and 83% respectively for 9355-15 and 9355-19, so the Mn should theoretically approximate 5000 Daltons.

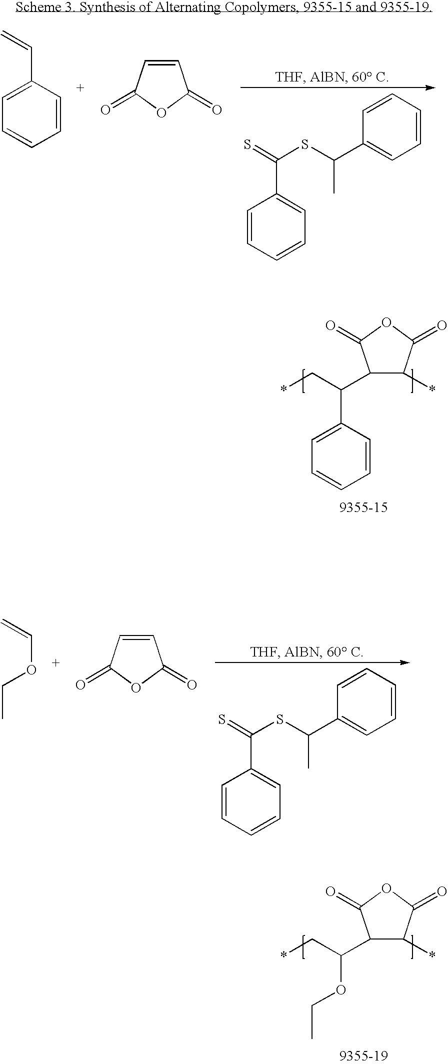

NMR spectra of the polymers show the expected broad peaks due to the polymeric nature of the materials, with the signals due to backbone protons and carbons being almost absent. More importantly, the IR spectra show signals due to the asymmetric and symmetric stretching of the anhydride rings at 1855 and 1776 cm⁻¹.

Modification of RAFT polymers with alkylamines (9355-16, 9355-17, 9355-34, 9355-20, 9355-21, 9355-35) (Smith, M. B. (1994), supra)

Addition of alkyl amines to carboxylic acid anhydrides results in the formation of an amide functional group and a free carboxylic acid, Scheme 4. Polymers 9355-15 and 9355-19 were dissolved into dry THF and the alkyl amine was slowly added followed by 18 to 24 hours of heating at reflux. The long reaction time and elevated temperature were employed to ensure complete reaction of the alkyl amine.

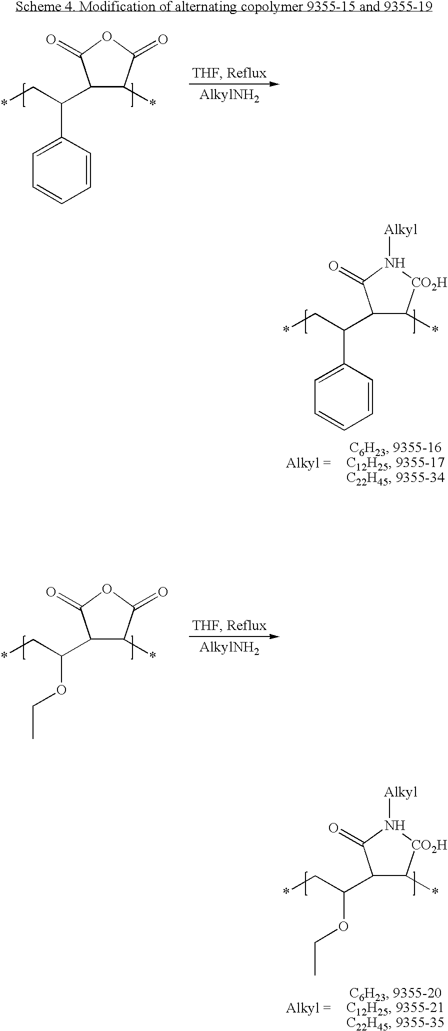

The polymers were vacuum dried at under high vacuum, however, only under extended heating could traces of residual THF be removed. All polymers were yellow orange solids with the exception of 9355-35, which turned a dark purple color upon heating to 90° C. under vacuum. The IR and NMR spectra are consistent with the expected polymer structure and the material is soluble in organic solvents. There are several possible explanations for the change of color from chemical changes of the dithiocarboxylate to changes in the polymer backbone. However, with the characterization data obtained, it is impossible to comment in a confident manner as to the nature of the color change.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A method of reducing wax deposition from a crude petroleum during transmission of the crude petroleum through a pipeline, the method comprising the steps of:
(a) mixing with the crude petroleum a polymer selected from the group consisting of:
(i) a poly(maleic anhydride-co-a-olefin) modified with long chain alkyl amine; and
(ii) a poly(maleic anhydride-co-alkyl vinyl ether) modified with long alkyl amine;
(iii) poly(maleic anhydride-co-styrene) modified with long chain alkyl amine; and
(b) transmitting the crude petroleum through a pipeline.

2. The method according to claim 1, wherein the long chain alkyl amine has at least 12 carbons.

3. The method according to claim 1, wherein the long chain alkyl amine has 18-24 carbons.

4. The method according to claim 1, wherein the polymer has a polydispersity index in the range of 1.0-1.5.

5. The method according to claim 1, wherein the polymer is poly(maleic anhydride-co-1-octadecene) modified with octadecyl amine.

6. The method according to claim 1, wherein the polymer is poly(maleic anhydride-co-ethyl vinyl ether) modified with docasanyl amine.

7. The method according to claim 1, wherein the polymer is present in the range of about 0.05% to about 1% by weight of the mixture with crude petroleum.

8. The method according to claim 7, wherein the polymer is effective at a concentration of 0.1% by weight of the mixture to suppress wax nucleation and to suppress the cloud point of the crude petroleum.

9. A method of testing the deposition of wax from a petroleum sample, the method comprising the steps of:
(a) assembling a test cell comprising:
(i) a first surface, wherein the first surface is defined by a heat-conductive body;
(ii) a second surface, wherein the second surface is defined by a transparent plastic plate; and
(iii) a channel for flow between the first surface and the second surface, wherein the channel is partially defined by a spacer positioned between the first surface and the second surface;
(b) controlling the temperature of the first surface; and
(c) passing the petroleum sample through the channel at a controlled temperature.

10. The method according to claim 9, wherein the first surface is oriented to be a lower surface and the second surface is oriented to be an upper surface.

11. The method according to claim 9, wherein the heat-conductive body is in the form of a plate.

12. The method according to claim 9, wherein the heat-conductive body is formed of copper metal.

13. The method according to claim 9, wherein the step of assembling further comprises applying a fine abrasive lapping compound to the first smooth surface to ensure uniform smoothness across the surface.

14. The method according to claim 9, wherein the step of controlling the temperature of the first surface comprises: passing water at a controlled temperature in contact with the heat-conductive body.

15. The method according to claim 9, wherein the transparent plastic plate comprises: polymethyl methacrylate.

16. The method according to claim 9, further comprising the steps of: measuring the temperature of the petroleum sample entering and leaving the cell; and measuring the temperature of the first surface.

17. The method according to claim 16, wherein the step of measuring the temperature of the first surface further comprises the steps of measuring the temperature of the first surface at two spaced-apart locations in the channel on the first surface.

18. The method according to claim 9, further comprising the steps of: measuring the differential pressure at two spaced-apart locations in the channel.

19. The method according to claim 9, further comprising the step of: including an additive in the petroleum sample.
